(19) United States
(12) Patent Application Publication
(10) Pub. No.: US 2009/0081963 A1
(43) Pub. Date: Mar. 26, 2009

(54) Wireless communication device with internal antenna system for use in hazardous locations

(75) Inventor: William Bret Boren, Southlake, TX (US)

Correspondence Address: WILLIAM BRET BOREN, 1000 BREEZE WAY, SOUTHLAKE, TX, 76092, US

(73) Assignee: IP Sensing, Inc., Southlake, TX (US)

(21) Appl. No.: 12/009,937

(22) Filed: Jan. 23, 2008

Related U.S. Application Data
(60) Provisional application No. 60/897,657, filed on Jan. 26, 2007.

(51) Int. Cl. H04B 1/38

(52) U.S. Cl. 455/90.1

(57) ABSTRACT

A self-contained radio frequency (RF) wireless communication device (100) comprising an explosion-proof housing (110), an internal electronic system for the conversion of radio wave and conducted electrical signals, and an internal antenna system located within a non-metallic portion (130) of the housing for collecting and emitting radio wave energy. The antenna system enables the wireless communication device (100) to safely collect and emit radio wave energy using one or more optimally configured antenna resonators (351), with each antenna resonator differing each other antenna resonator by at least one attribute in a group of attributes comprising: frequency response, field polarization, and wavelength spatial diversity.

The present invention is a self-contained RF wireless communication device that provides data communications between two or more devices for the supervisory control and/or data acquisition of actuators, sensors, transducers, gas detectors, and other devices located in explosive hazardous locations without the need of installing one or more external antennas, one or more antenna connectors, excessive conduit connections and seals, and the like, whereby reducing system installation components count and eliminating conduit connections, furthermore reducing the probability of system-level failures caused by lower-level faults of components and conduit connections, resulting in a less expensive and safer electrical equipment installation.

### CROSS-REFERENCES TO RELATED APPLICATIONS AND INFORMATION DISCLOSURE

This application claims benefit of U.S. Provisional Application Ser. No. 60/897,657 filed Jan. 26, 2007.

| | | |
|---|---|---|
| 6,900,565 | May, 2005 | Preston |
| 7,057,577 | June 2006 | Willoughby, et al. |
| 7,014,502 | March 2006 | Rasmussen |
| 6,978,165 | December 2005 | Martinez, et al. |
| 6,967,589 | November 2005 | Peters |
| 6,894,659 | May, 2005 | Pepperling, et al. |
| 6,794,991 | September 2004 | Dungan |
| 6,369,715 | April 2002 | Bennett, Jr., et al. |

### OTHER REFERENCES AND DISCLOSURE INFORMATION

1. Titan Industries, Inc. publication entitled “CK-485MX Wireless Transceiver”, document number DOC485MX, version 2.0, pages 2-6, author Dr. Brian Kopp, published Jun. 6, 1997 and downloaded from the www.titan-solutions.com on Dec. 26, 2006.
2. Titan Industries, Inc. publication entitled “RTU System Radio Installation”, document number TI-INSTALL-1, rev 0, sheet 1 of 1, drawn by Lloyd, dated May 17, 1999 and downloaded from the website www.titan-solutions.com on Dec. 26, 2006.
3. Honeywell Inc. publication entitled “XYR5000 Series Wireless Transmitters”, pages 1-8, published prior to Dec. 26, 2006 and downloaded from the website www.lesman.com on Dec. 26, 2006.
4. Detcon Inc. publication entitled “Detcon's Model Series 700, Environmentally Bulletproof, Gas Detection Sensors”, Catalog #700-0806, page 5 of 6, published prior to Jan. 1, 2007 and downloaded from the website www.detcon.com on Dec. 26, 2006.
5. IP Sensing, Inc., publication entitled “In-ground Radio Technical Specifications”, author Bret Boren, pages 1-2, published Jun. 22, 2006, published at Axxea Systems as sales material and presented to public June 2006.
6. IP Sensing, Inc., publication entitled “RS485 Transponder Unit”, author Bret Boren, sheets 1-2, published Oct. 19, 2006, published at Axxea Systems as sales material and presented to public October 2006.
7. IP Sensing, Inc., publication entitled “Explosion-proof RS485 Transponder Unit”, author Bret Boren, sheets 1 of 1, published Oct. 24, 2006, published at Axxea Systems as sales material and presented to public October 2006.
8. IP Sensing, Inc., publication entitled “IPS120A1—Stainless Steel Cap”, author Bret Boren, sheets 1 of 1, published Oct. 16, 2006, published at Axxea Systems as manufacturing specification for engineering prototype.
9. IP Sensing, Inc., publication entitled “IPS119A1—Black ABS Tube”, author Bret Boren, sheets 1 of 1, published Oct. 16, 2006, published at Axxea Systems as manufacturing specification for engineering prototype.

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

1. Field of the Invention

The present invention is related to a wireless communication device, and more particularly to a wireless communication device having a radio frequency (RF) transceiver, an internal antenna system, data converter circuitry, and a particular housing design dependent on the internal antenna system and hazardous location electrical equipment installation requirements.

2. Background Art

There are many applications today where electrical connections are made in hazardous environments, such as locations where ignitable concentrations of flammable gases, vapors or liquids are present or may become present through accident or abnormal operation. Hazardous locations comprise areas such as hydrocarbon drilling operations, natural gas processing and transmission facilities, as well as dust-laden operations such as grain processing facilities. For instance, Article 500 of the National Electrical Code (“NEC”) NFPA 70 has classified certain locations as hazardous, including Class I (combustible material in the form of gas vapors) and Class II (combustible material in the form of dust).

Electrical devices mounted in hazardous locations are generally required to be in an explosion-proof enclosure or be classified as intrinsically safe. By mounting electrical devices in explosion-proof enclosures, the likelihood of an explosion caused by electrical arching, such as opening and closing of a contact or non-sealed relay device, is significantly reduced. An explosion-proof enclosure is not necessary if the electrical device is classified as intrinsically safe, which generally means the circuits of the device are of such low power that they are incapable of causing ignition. However, performance of many electrical devices is degraded when power is limited and the lack of performance must be compensated with installation of additional system components elsewhere.

As required by the NEC, electrical wiring/cable in hazardous locations are required to pass through a rigid metal conduit connection system from location to location, such as from an instruments enclosure housing to a junction box outside the instrument or to the plant electrical distribution system. The NEC requires that explosion-proof conduit seals be installed in the rigid metal conduit connections to prevent hazardous gases, vapors or flames in one region of the electrical installation from passing to another region through the conduit pipe connection in the event of an internal explosion. However, these conduit seals are expensive and their installation is labor intensive. Furthermore, removal of the seal for maintenance or service of the electrical system is exceedingly difficult and typically requires either cutting the seal fitting off of the conduit system or chipping away the sealing compound contained within the fitting, which either method may result in accidentally cutting the wire/cable contained therein.

Wireless communication systems are common electrical equipment installed in hazardous locations used for maintaining processes and safety by supervisory control and data acquisition of equipment, such as gas detectors, pressure sensors, and shutoff valves. As will be shown herein, the referenced related art demonstrates the installation of wireless communication devices in hazardous locations to involve numerous system components, such as explosion-proof enclosures, conduit seals, antenna connectors, and antennas, to complete a wireless communication system installation. The industrial marketplace drives for safer electrical equipment installations in hazardous locations by reducing the number of system components required in the installation. The reduction of the system components count and conduit connections in an installation inherently reduces the probability of system-level failures caused by lower-level faults of the components and conduit connections. The desirability of creating a safer wireless system while reducing components and conduit connections provides challenges to the device designers in achieving optimal system performance, and more particularly as in the present invention, optimizing antenna system performance using a multiple antenna diversity system.

U.S. Pat. No. 7,057,577 to Willoughby, et al., June 2006, (assigned to Ventek, LLC of West Chester, Ohio). This prior art invention provides the ability to adapt a standard RF antenna for use as a component in a hazardous location. However, separate components including an explosion-proof enclosure, RF transceiver, and RF antenna are needed to complete the wireless communication system. The present invention is a complete explosion-proof, self-contained wireless communication device with built-in system components including an RF transceiver, one or more RF antennas, and a conduit seal thus making installation safer by reducing the need for separate system components and the required conduit connections and seals between the separate components.

U.S. Pat. No. 7,014,502 to Rasmussen, March 2006, (assigned to AnLynk Wireless, LLC of Columbus, Ohio). This related art invention attempts to provide an RF antenna component for use in a hazardous location to simplify installation of a wireless system. However, an explosion-proof enclosure, an RE transceiver, coaxial cabling, and conduit seals are still needed to complete the wireless communication system using this device and therefore requiring additional components in the system, thereby increasing the probability for system-level failures caused by lower-level faults at the components and conduit connections. The present invention is a complete explosion-proof, self-contained wireless communication device with built-in system components including an RF transceiver, one or more RF antennas, and a conduit seal thus making installation safer by reducing the need for separate system components, required conduit connections, and seals between the separate components.

U.S. Pat. No. 6,900,565 to Preston, May 2005, (assigned to Airex Corporation of Anaheim, Calif.). This related art invention demonstrates a motor controller apparatus with a claim of explosion-proof compliance with the National Electrical Code, NFPA 70 and shows similar engineering challenges in designing an explosion-proof product for installation and use in hazardous locations.

U.S. Pat. No. 6,978,165 to Martinez, et al., December 2005, (assigned to Motorola, Inc. of Schaumburg, Ill.). Like the present invention, this related art invention discloses an apparatus with an RF transceiver and built-in RF antenna system used to provide wireless communication. Unlike this present invention which is capable of installation at an explosive hazardous location, this related art device does not have the difficult design requirements and limitations as an apparatus used in an explosive hazardous location. Integration of system components into a single apparatus as with this related art is desirable to achieve a compact, less expensive, and safer product solution. As with the present invention, integration is desirable for the increase in safety by reducing the probability of system-level failures caused by lower-level faults. The desirability of a more compact and safer wireless communication system provides challenges to the design engineers in achieving optimal antenna performance, much like the challenges of antenna design referenced in this related art patent.

U.S. Pat. No. 6,967,589 to Peters, November 2005, (assigned to OleumTech Corporation of Irvine, Calif.). This related art invention solves the problem of wireless communication in a hazardous location by operating a low-power RF transceiver and its RF antenna at an intrinsically safe power level that is incapable of causing an ignition in the hazardous location. A high-power RF transceiver and its RF antenna are then installed a short distance away in a non-hazardous location to relay the wireless communication data to a further distant base station. An apparent problem with this invention is the intrinsically safe low-power RF transceiver limits the distance performance of the wireless communication device and therefore requires additional electrical equipment to extend the wireless communication distance and therefore more system components to increase probability of system level-failures. This present invention enables the placement of a high-power RF transceiver and one or more RF antennas directly in the hazardous location, thereby directly enabling high-performance long distance wireless communication with the single equipment installation.

U.S. Pat. No. 6,894,659 to Pepperling, et al., May 2005, (assigned to Daniel Industries, Inc. of Houston, Tex.). This related art invention discloses a common solution to providing wireless communication in a hazardous location with the installation of a RF transceiver in an explosion-proof enclosure and then mounting its RF antenna external to the enclosure. However, the invention does not address the complex problem of coupling the RF transceiver to its RF antenna while meeting the requirements for electrical equipment installation in hazardous locations. The present invention meets the requirements for placement of both the RF transceiver and one or more RF antennas in a hazardous location, furthermore reducing system component count and improving safety.

U.S. Pat. No. 6,794,991 to Dungan, September 2004, (assigned to Gastronics' Inc. of Cleveland, Ohio). This related art invention discloses a wireless communication monitoring system for use in a hazardous location and the need for such type of a system for supervisory control and data acquisition. The related art patent discloses an RF transceiver installed in an explosion-proof enclosure and a separate antenna external to the enclosure using an antenna connector such as the one described in the referenced Willoughby, et al. U.S. Pat. No. 7,057,577 patent. The present invention addresses the wireless communication installation with less system components using a complete explosion-proof, self-contained wireless communication apparatus that includes a built-in RF transceiver and one or more RF antennas thus reducing system component count and improving safety.

U.S. Pat. No. 6,369,715 to Bennett, Jr., et al., April 2002, (assigned to Innovative Sensor Solutions, LTD of Houston, Tex.). This related art invention discloses a wireless communication apparatus for use in a hazardous location and the need for such type of devices. The invention solves the problem of wireless communication in a hazardous location by operating a low-power RF transceiver and its RF antenna at an intrinsically safe power level incapable of causing an ignition in the hazardous location and then installing a high-power RF transceiver and its RF antenna a short distance away in a non-hazardous location to relay the wireless communication data. The present invention is not restricted by the intrinsically safe electronics requirements in limiting RF transmitter power and therefore has substantially longer distance and does not require a radio repeater to gain distance. This prior art patent further discloses in “Background of the Invention” some difficulties encountered when attempting to design an apparatus where the RF transceiver and RF antenna are integrated together in an explosion-proof enclosure as the innovative invention has successfully achieved, therefore, giving additional evidence on the unobviousness and novelty of the present invention by those skilled in the art.

As shown in the related art of Bennett U.S. Pat. No. 6,369,715, Peters U.S. Pat. No. 6,967,589, and the referenced Honeywell, Inc. publication entitled “XYRS000 Series Wireless Transmitters”, it is indeed frequent practice to operate a low-power RF transceiver or low-power RF transmitter and its RF antenna at an intrinsically safe power level incapable of causing an ignition in the hazardous location and then installing a high-power RF transceiver and its RF antenna a short distance away to relay the wireless communication data to a further distance. However, additional components of an explosion-proof enclosure, conduit seals, RF transceivers, RF transmitters, and RF antennas to function as radio repeaters to increase distance is expensive and makes the installation process more difficult and increases probability of system failure. The present invention allows placement of the high-power RF transceiver and one or more RF antennas directly in the hazardous location, thereby enabling longer distance wireless communication than the related arts using less system components, thereby decreasing the probability for system-level failures caused by lower-level faults at the components and conduit connections.

As shown in the related art Dungan U.S. Pat. No. 6,794,991, Pepperling U.S. Pat. No. 6,894,659, Rasmussen U.S. Pat. No. 7,014,502, Willoughby U.S. Pat. No. 7,057,577, the referenced Titan Industries, Inc. publication entitled “CK-485MX Wireless Transceiver”, the referenced Titan Industries, Inc. publication entitled “RTU System Radio Installation”, and the referenced Detcon, Inc. publication entitled “Detcon's Model Series 700, Environmentally Bulletproof, Gas Detection Sensors” it is indeed frequent practice to locate RF transceivers inside explosion-proof enclosures and locate the RF antenna externally to the enclosure for better reception. However, explosion-proof enclosures, multiple conduit seals, special antennas, and special antenna connectors are expensive and make the installation process more difficult and less safe. The present invention is a complete explosion-proof, self-contained wireless communication device with built-in system components including an RF transceiver, one or more RF antennas, and a conduit seal thus making installation safer by reducing the need for the separate system components and the required conduit connections and seals between the separate components.

Thus, there is a need for an explosion-proof wireless communication apparatus with internal antenna system and factory-installed sealed conduit port for use in hazardous location to simplify installation efforts, reduce system components count, and allow better wireless distance performance, whereby providing a more reliable and safer wireless communication system for hazardous location use.

The integration of a RF transceiver, one or more RF antennas, and sealed conduit port in a single explosion-proof wireless communication device as done in the present invention is unique, provides challenges to the device designers in achieving optimal antenna system performance, is novel and not obvious to those skilled in the art as shown in the referenced related arts, and has many utility advantages over the recently patented prior related arts attempting to address similar problems.

### BRIEF SUMMARY OF THE INVENTION

Electrical devices mounted in hazardous locations are generally required to be in an explosion-proof enclosure or be classified as intrinsically safe. By mounting electrical devices in explosion-proof enclosures, the likelihood of an explosion caused by electrical arching, such as opening and closing of a contact or non-sealed relay device, are significantly reduced. An explosion-proof enclosure is not necessary if the electrical device is classified as intrinsically safe, which generally means the circuits of the device are of such low power that they are incapable of causing ignition. However, performance of many electrical devices is degraded when power is limited and the lack of performance must be compensated with installation of additional system components elsewhere.

As shown in the related art, it is indeed frequent practice to operate a low-power RF transceiver or low-power RF transmitter and its RF antenna at an intrinsically safe power level incapable of causing an ignition in the hazardous location and then installing a high-power RF transceiver and its RF antenna a short distance away to relay the wireless communication data to a further distance. However, additional components of an explosion-proof enclosure, conduit seals, RF transceivers, RF transmitters, and RF antennas to function as radio repeaters to increase distance is expensive and makes the installation process more difficult and increases probability of system failure. The present invention invention allows placement of the non-intrinsically safe RF transceiver and one or more RF antennas directly in the hazardous location, thereby enabling longer distance wireless communication than the related arts using less system components, thereby decreasing the probability for system-level failures caused by lower-level faults at the components and conduit connections.

As shown in the related art, it is indeed frequent practice to locate RF transceivers inside explosion-proof enclosures and locate the RF antenna externally to the enclosure for better reception. However, explosion-proof enclosures, multiple conduit seals, special antennas, and special antenna connectors are expensive and make the installation process more difficult and less safe. The present invention is a complete explosion-proof, self-contained wireless communication device with built-in system components including an RF transceiver, one or more RF antennas, and a conduit seal thus making installation safer by reducing the need for the separate system components and the required conduit connections and seals between the separate components.

The present invention is a self-contained RF wireless communication device that provides data communications between two or more devices for the supervisory control and/or data acquisition of actuators, sensors, transducers, gas detectors, and other devices located in explosive hazardous locations without the need of installing explosion-proof enclosures, one or more external antennas, one or more antenna connectors, excessive conduit connections and seals, and the like, whereby reducing system installation components count and eliminating conduit connections, furthermore reducing the probability of system-level failures caused by lower-level faults of components and conduit connections, resulting in a less expensive and safer electrical equipment installation.

### BRIEF DESCRIPTION OF THE SEVERAL VIEWS OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 is a view of one embodiment of a wireless communication device.

FIG. 1B is a view of a second embodiment of a wireless communication device.

FIG. 2 is an end view of the wireless communication device of FIG. 1.

FIG. 2B is an end view of the wireless communication device of FIG. 1B.

FIG. 3 is a cross sectional view of the wireless communication device of FIG. 1.

FIG. 3B is a cross sectional view of the wireless communication device of FIG. 1B.

FIG. 4 is a view of a third embodiment of a wireless communication device.

FIG. 5 is an end view of the wireless communication device of FIG. 4.

FIG. 6 is a cross sectional view of the wireless communication device of FIG. 4.

FIG. 7 is a view of a forth embodiment of a wireless communication device.

FIG. 8 is an end view of the wireless communication device of FIG. 7.

FIG. 9 is a cross sectional view of the wireless communication device of FIG. 7.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily electrically or mechanically. The terms program, software application, and the like as used herein, are defined as a sequence of instructions designed for execution on a computer system, or programmable controller, or the like. A program, computer program, or software application may include a subroutine, a function, a procedure, an object method, an object implementation, an executable application, an applet, a source code, an object code, a shared library/dynamic load library and/or other sequence of instructions are designed for execution on a computer system, or programmable controller, or the like.

Explosion-proof housings for use in hazardous locations are defined as housings that significantly reduce the likelihood of an explosion caused by electrical arching, more particularly a housing which is capable of: 1) withstanding an internal explosion of a specified gas or vapor-in-air atmosphere; 2) preventing the ignition of a specified gas or vapor-in-air atmosphere surrounding housing due to sparks, flashes or internal explosion; and 3) operating at temperatures which will not ignite the surrounding atmosphere.

A capsule is defined as a form of housing or enclosure that is generally small and compact. A capsule typically is a housing of minimal size to enclose only a specific system to were the internal free space is minimized. The shape and size of the capsule will vary to enclose the system and meet other structural requirements. For the present invention, the capsule walls are defined as comprising: the perimeter walls enclosing the capsule internal region, the sealed ports enclosing the capsule internal region, and any open ports or joint gaps in the perimeter walls enclosing the capsule internal region.

Encapsulated enclosure casting compound is defined as a compound used to partially encapsulate a component, conductor, and/or system while also serving as part of an enclosure wall.

Intrinsically safe circuits for use in hazardous locations are defined as circuits which are incapable of causing ignition, more particularly a circuit in which a spark or thermal effect, produced either normally or in specified fault conditions, is incapable under certain conditions of causing ignition of a mixture of flammable or combustible material in air in the mixture's most easily ignited concentration.

Electrical devices in an explosion-proof housing typically couple to, operate, or take inputs from devices external to the explosion-proof housing. Generally speaking, this communication with the outside world takes place through electrical conductors coupled to the external devices. These electrical conductors reach the explosion-proof enclosures through electrical rigid metal conduits.

Electrical conduit connections in hazardous locations have conduit seals that generally have a sealing compound to literally seal the conduit and wire/cable contained therein at that location, whereby preventing harmful fluids and vapors traveling in the conduit past that sealed point. In particular, the conduit sealing compound forms a seal around each electrical conductor and with the internal diameter of the conduit. This conduit seal restricts the passage of gases, vapors and/or flames through the conduit.

A wireless modem is defined as a device that enables a computer or electronic device to transmit data over a private wireless data network or a wireless telephone system, or the like. Computer and electronic device data is stored in digital form, whereas data transmitted by RF wireless communication is transmitted in the form of electromagnetic radio waves. A wireless modem converts between the stored digital data form and the transmitted radio wave data form. Examples of wireless modem products are a IEEE 802.11b WiFi wireless LAN network card and a GSM (Global System for Mobile Communication) wireless modem for laptop computers.

Antenna resonator is define as an active antenna element. An antenna ground plane is defined as an antenna grounding structure. The term “antenna” by itself is defined as an active antenna element referenced to a common antenna grounding structure.

Multiple antenna diversity is defined as a method intended to overcome frequency interference and a fading phenomenon due to a multi-path phenomenon of a radio wave signal in a wireless propagation environment. A multiple antenna diversity system allows multiple frequency bands of operation and forms multiple radio signal paths un-correlated with each other on space and/or on antenna polarization through multiple antennas, and then receives a signal through the minimum interfered or minimum fading signal path to optimize antenna system performance. Many existing wireless communication systems widely used in an indoor environment where frequency interference and fading phenomenon is serious, such as a wireless LAN, use such a defined multiple antenna diversity system to select between different frequency bands and physical antenna resonators to optimize antenna system performance.

The concept of the present invention can be advantageously used on any electronic device requiring a wireless modem capable of transmission and/or reception of RF data signals. The wireless modem portion (350, 650, 950) of the invention may be constructed in accordance with a digital communication standard or an analog communication standard, whereby allowing wireless data communication via a switched telephone network or private wireless data network. The wireless modem portion (350, 650, 950) generally includes an RF transceiver, at least one antenna resonator, a frequency synthesizer, modulator, demodulator, a signal processor, data converter circuitry, and a serial data UART for interfacing to a computer, electronic device, or the like. The wireless modem electronics typically incorporated into an IEEE 802.11b WiFi wireless network card, GSM cellular wireless modem, SCADA two-way radio, or the like are well known in the art, and can be incorporated into the wireless communication device of the present invention.

The data converter portion being defined as either a non-intrinsically safe data converter portion or an intrinsically safe data converter portion of the invention allows conducted electrical data communication with external electronic devices and may be constructed in accordance with a digital communication standard or an analog communication standard or an I/O protection circuit or simple voltage divider, whereby allowing data communication via methods including serial data communication and analog communication, such as RS-232, RS-485, and 4-20 mA analog current loop used on devices such as gas detectors, gas sensors, pressure sensors, flow valves, solenoid actuated valves, and alarm control panels. The data converter portion generally can include I/O circuit protection, voltage level conditioner circuitry, threshold comparator, A/D converter, D/A converter, driver circuitry, a programmable controller, and a serial data UART for data communication interfacing. The data signal converter electronics typically incorporated into a RS-485 serial converter product, 4-20 mA current loop transceiver product, gas detector, pressure gauge, analog input sensor, acoustic sensor, shutoff valve controller, or the like are well known in the art, and can be incorporated into the wireless communication device of the present invention.

The intrinsically safe data converter portion of the invention further allows safe conducted electrical data communication with external electronic devices and may be constructed in accordance with a digital signal standard or an analog signal standard or an I/O protection circuit or simple voltage divider, whereby allowing safe data transfer in hazardous locations via methods including serial data communication, analog communication, and analog signal sampling, such as RS-232, RS-485, 4-20 mA analog current loop, synchronous serial data, and 0-10 volt analog transducer signals used on devices such as video cameras, microphones, speakers, piezoelectric devices, electrochemical sensors, gas detectors, gas sensor transducers, pressure sensor transducers, acoustic transducers, flow meters, and shutoff solenoid valves. The intrinsically safe data converter portion generally can include intrinsically safe barrier devices, I/O circuit protection, a voltage level conditioner circuit, threshold comparator, A/D converter, D/A converter, driver circuit, a programmable controller, and a serial data UART for data communication interfacing. The intrinsically safe data converter electronics typically incorporated into a RS-485 serial converter product, 420 mA analog current loop transceiver product, gas detector, pressure gauge, analog input sensor, acoustic sensor, shutoff valve controller, or the like are well known in the art, and can be incorporated into the wireless communication device of the present invention. The intrinsically safe data converter portion provides an intrinsically safe barrier method to prevent an ignition at its interface to the explosive atmosphere hazardous location, whereby making it an intrinsically safe circuit, as previously defined herein.

The power supply portion being defined as either a non-intrinsically safe power supply portion or an intrinsically safe power supply portion may be constructed in accordance with an I/O protection circuit, simple voltage divider, standard linear regulator, a switching AC-to-DC power supply, a DC-to-DC power supply design, or a battery circuit. The intrinsically safe and non-intrinsically safe power supply portions generally can include I/O circuit protection, linear regulators, storage capacitors, inductors, diodes, batteries, and controller integrated circuits. The intrinsically safe and non-intrinsically safe power supplies typically incorporated in electronic devices and devices used in hazardous environments such as gas detectors, pressure sensors, shutoff valve controllers, or the like are well known in the art, and can be incorporated into the communication device of the present invention. The intrinsically safe power supply portion provides an intrinsically safe barrier method to prevent an ignition at its interface to the explosive atmosphere hazardous location, whereby making it an intrinsically safe circuit, as previously defined herein.

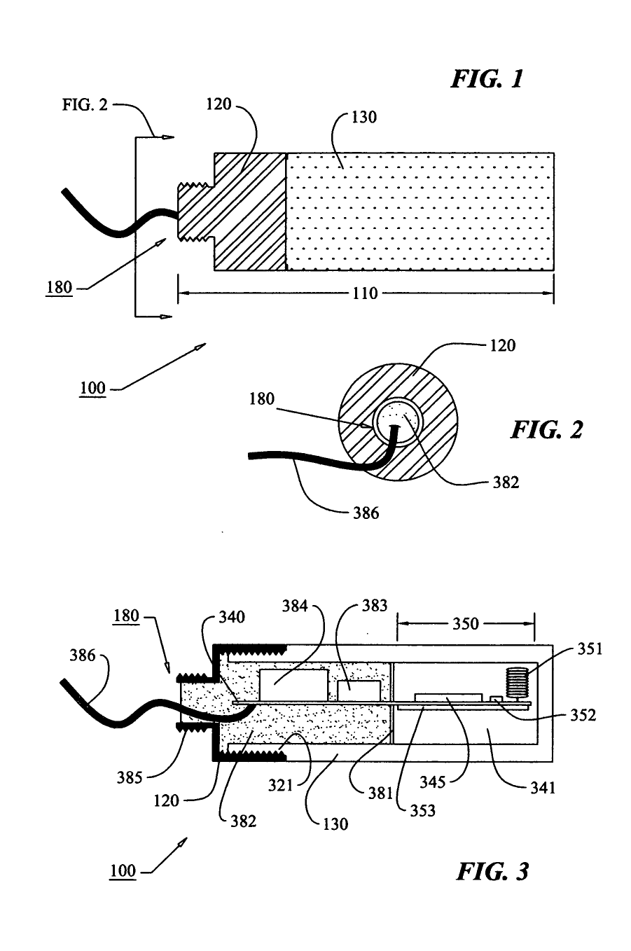

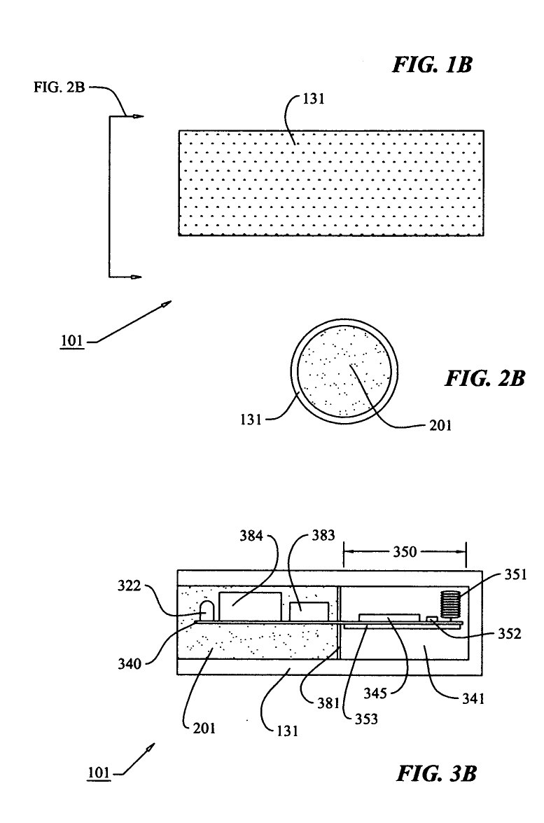

The illustrated wireless communication device 100 in FIG. 1, by way of example only, is one preferred embodiment of a wireless communication device, in accordance with the present invention, having a conventional wireless modem circuitry, data converter circuitry, and power supply circuitry, as is known in the art, and will not be presented here for simplicity. Although the invention is illustrated herein with reference to a wireless communication device for hazardous locations, the invention is alternatively applied to other applications such as, for example, supervisory control and data acquisition of devices in non-hazardous locations like residential, commercial, and industrial security systems with electrochemical sensors, radiated energy sensors, and solenoid actuators.

The wireless communication device 100, as illustrated, includes a capsule 110 for covering, protecting and supporting the internal components encased within, along with providing mechanical structure for interfacing to external devices. By way of example, the preferred embodiment of the present invention is described in relation to a fixed housing such as the capsule 110 of FIG. 1; however, it will be appreciated by one of ordinary skill in the art that the present invention is similarly applicable to a housing of different shape and length to incorporate different electronic circuitry and/or different internal antenna systems that may vary in size due to number of spatially separated antenna resonators, frequency of operation, radiation pattern, polarization, and characteristic impedance.

In accordance with the present invention, the capsule 110 comprises a conduit fitting portion 120 and a non-metallic portion 130. The non-metallic portion 130, for example, can be manufactured by a plastic injection molding technique as is well known in the art. The conduit fitting portion 120 is preferably made of a material to provide the capsule 110 a rigid metal conduit mechanical interface structure with more strength than housing comprised totally of the non-metallic portion 130 material so that the conduit port 180 will be in accordance with Article 501 in the National Electric Code (“NEC”) ANSI/NFPA 70-2005. The conduit fitting portion 120, for example, can be manufactured using any material which from a mechanical point of view is any physical element showing very high tensile strength. Such materials include iron, aluminum, stainless steel, or a non-metallic material with similar strength to achieve the same result. The conduit fitting portion 120 provides strength and rigidity over a non-metallic material, such as glass reinforced plastic, used for the non-metallic portion 130. While one could attempt to integrate the conduit fitting portion 120 with the non-metallic portion 130 to create an integrated single piece housing and manufacture the integrated housing out of a high-grade non-metallic material in order to design around or improve the patent, the insubstantial change to an integrated single piece housing would in effect be deemed equivalent to the present invention since it would perform substantially the same function, in substantially the same way, to yield substantially the same result.

In accordance with the present invention, the capsule 110 comprises one non-metallic portion 130 and one conduit fitting portion 120. While one could attempt to break the non-metallic portion 130 into two portions comprising a non-metallic portion for housing the antenna system, whereby allowing radio wave penetration, and another portion of non-metallic or metallic material, whereby attempting to design around or improve the patent, the insubstantial change in dividing the non-metallic portion 130 to multiple portions would in effect be deemed equivalent to the present invention since it would perform substantially the same function, in substantially the same way, to yield substantially the same result.

FIG. 2 is an end view of the wireless communication device 100 of FIG. 1, looking at the conduit port 180.

FIG. 3 is a cross sectional view of the wireless communication device 100 of FIG. 1. As illustrated, the communication device 100 includes the capsule 110 and a plurality of internal components. The capsule 110 encases the plurality of internal components, providing covering, protection, and interface port mechanical structural support. The plurality of internal components, for example, can include an RF transceiver 345, (or alternatively a separate RF transmitter and RF receiver (not shown)), interface lead wires 386 serving as a plurality of conduit port electrical conductors, a power supply portion 384, a data converter portion 383, and the like. The plurality of internal components, in accordance with the present invention, preferably further includes an antenna RF switch 352, an antenna resonator 351, and an antenna grounding structure 353. The plurality of internal components further can comprise, as described previously herein for functionality, of I/O circuit protection, programmable controllers, a frequency synthesizer, a signal processor, serial data UART devices, voltage level conditioner circuits, threshold comparators, A/D converters, D/A converters, driver circuits, linear regulators, storage capacitors, inductors, diodes, switch mode controller integrated circuit, and the like. A printed circuit board 340 provides conducted electrical connection and mechanical structure between the plurality of internal components within the wireless communication device 100 as illustrated.

In accordance with the present invention, the capsule 110 comprises one non-metallic portion 130 and one conduit fitting portion 120 joined together by assembly of two mating threaded sections to make the threaded joint 321. While one could attempt to use a rabbet joint, straight or flat joint, labyrinth joint, or the like instead of the threaded joint 321 as specified in the present embodiment, whereby attempting to design around or improve the patent, the insubstantial change to a different type of mating joint would in effect be deemed equivalent to the present invention since it would perform substantially the same function, in substantially the same way, to yield substantially the same result.

In accordance with the present invention, an antenna system for the wireless communication device 100 comprises the antenna resonator 351, the antenna RF switch 352, and the antenna grounding structure 353. The antenna resonator 351 and the antenna grounding structure 353 can be built in different ways and using different technologies as is well known in the art. For example, the antenna resonator 351 can be a helix-whip coupled to quarter-wave image grounding structure, a meandered encapsulated flexible circuit, a meandered none encapsulated flexible circuit, one or more meandered wires, any combination of active and parasitic radiators, and the like. The antenna system functions using the combination of all the mechanical parts that constitute the antenna system and its switches necessary to carry the RF signal from and towards the RF transceiver 345 including the antenna resonator 351, the antenna RF switch 352, coupled between the antenna resonator 351 and the RF transceiver 345. The antenna system is for radiating and collecting radio wave energy and is coupled and matched with circuitry within the plurality of internal components such as the RF switch 352 as is known in the art.

As illustrated, the antenna resonator 351 of the antenna system is located within the non-metallic portion 130 of the capsule 110 in accordance with the present invention. Locating the antenna resonator 351, the antenna RF switch 352, and the antenna grounding structure 353 within the non-metallic portion 130 decreases the probability of the antenna system being shielded or detuned from the impedance of interest, thereby providing consistent overall antenna system performance efficiency. While one could attempt to use a conduit fitting portion 120 made of metal as a portion of the antenna resonator 351 or a portion of the antenna grounding structure 353 instead of locating them entirely in the non-metallic portion as specified in the present invention, whereby attempting to design around or improve the patent, the insubstantial change to the antenna system would in effect be deemed equivalent to the present invention since it would perform substantially the same function, in substantially the same way, to yield substantially the same result.

As illustrated in FIG. 3, the wireless communication device 100 includes a conduit port 180 for electromechanical interfacing to a rigid metal electrical conduit connection system or to an electrical enclosure, junction box, or the like. The conduit fitting portion 180 has within a conduit sealing compound 382 to incorporate a factory-installed conduit seal, as previously described herein. The factory-installed conduit seal is specified to withstand a minimum 600 PSIG hydrostatic pressure test applied at the conduit port 180, whereby the conduit fitting portion 120, conduit port threaded portion 385, and the conduit sealing compound 382 are designed to withstand the force of an explosion, eliminating the need for a separate conduit seal at the point where the device connects to an electrical conduit, an electrical enclosure, or the like. The interface lead wires protruding out the conduit port 180, and having the conduit sealing compound 382 forming a seal around each electrical conductor, provide conducted electrical coupling to the power supply portion 384 and the data converter portion 383.

In accordance with the present invention, the conduit port 180 has within a conduit sealing compound 382 to incorporate a factory-installed conduit seal, as previously defined herein. While one could attempt to remove the conduit sealing compound 382 in order to design around or improve the patent, the insubstantial change would in effect be deemed equivalent since an external conduit seal must then be installed and the wireless communications device would perform substantially the same function, in substantially the same way, to yield substantially the same result.

As illustrated in FIG. 3, a conduit sealing compound barrier 381 prevents the conduit sealing compound 382 from entering the wireless modem cavity 341. While one could attempt to remove the conduit sealing compound barrier 381 and fill the wireless modem cavity 341 with a sealing compound or potting material in order to design around or improve the patent, the insubstantial change would in effect be deemed equivalent since it would perform substantially the same function, in substantially the same way, to yield substantially the same result.

In accordance with the present invention, the conduit port threaded portion 385 is specified as an external thread on the first end of the conduit fitting portion 120 for interfacing to a rigid metal conduit connection system, or the like. While one could attempt to use an internal thead for the conduit port theaded portion 385 instead of an external thread as specified in the present invention, whereby attempting to design around or improve the patent, the insubstantial change to the different gender thread would in effect be deemed equivalent to the present invention since it would perform substantially the same function, in substantially the same way, to yield substantially the same result.

FIG. 3 further illustrates one embodiment of the wireless modem portion 350 for use within the wireless communication device 100 in accordance with the present invention and the relationship of the various portions of the wireless modem portion 350 with the various portions of the housing 110. As illustrated, the wireless modem portion 350, in accordance with a preferred embodiment of the present invention, comprises a printed circuit board 340 and associated internal components connected therein preferably housed within the non-metallic portion 130 of the capsule 110 as previously described herein. The wireless modem 350 further preferably comprises an antenna system contained within the non-metallic portion 130 of the capsule 110. It will further be appreciated by those of ordinary skill in the art that the wireless modem 350 can be utilized for all communication protocols such as FHSS (Frequency Hopping Spread Spectrum), DSSS (Direct Sequence Spread Spectrum), DTS (Digital Modulation Spectrum), WLAN (Wireless Local Area Network), TDMA (time division multiple access), CDMA (Code Division Multiple Access), GSM (Global System for Mobile Communication), and the like. It will be further appreciated that the wireless modem 350 can be utilized for data transmit and receive such as operating with GPRS (General Packet Radio Service), EDGE (An edge device is a physical device that can pass packets between a legacy type of network such as an Ethernet network and an ATM network, using Data Link layer and Network layer information), 3G (third-generation wireless) for facilitating the use of wireless data transfer, Internet access, and the like.

In accordance with the present invention, the interface lead wires 386 protruding from the conduit port 180 are coupled to the power supply portion 384, whereby providing a means for the power supply portion 384 to receive electrical power from an external source connected to the conduit port 180. The power supply portion 384 is coupled to the data converter portion 383 and the wireless modem portion 350, whereby the power supply portion 384 is capable of providing electrical power to the data converter portion 383 and the wireless modem portion 350.

In accordance with the present invention, the interface lead wires 386 protruding from the conduit port 180 are coupled to the data converter portion 383, whereby providing a means for the data converter portion 383 to transfer data with an external electronic device connected to the conduit port 180. The non-intrinsically safe data converter portion 383 is coupled to the wireless modem portion 350, whereby providing wireless communication ability for an external electronic device connected to the conduit port 180.

The illustrated wireless communication device 101 in FIG. 1B, by way of example only, is another preferred embodiment of a wireless communication device, in accordance with the present invention, having a conventional wireless modem circuitry, data converter circuitry, and power supply circuitry, as is known in the art, and will not be presented here for simplicity. Although the invention is illustrated herein with reference to a wireless communication device for hazardous locations, the invention is alternatively applied to other applications such as, for example, supervisory control and data acquisition of devices in non-hazardous locations like residential, commercial, and industrial security systems with electrochemical sensors, radiated energy sensors, and solenoid actuators.

The wireless communication device 101, as illustrated, includes a capsule 131 for covering, protecting and supporting the internal components encased within, along with a potting compound 201 to seal the open end of the capsule. By way of example, the preferred embodiment of the present invention is described in relation to a fixed housing such as the capsule 131 of FIG. 1B; however, it will be appreciated by one of ordinary skill in the art that the present invention is similarly applicable to a housing of different shape and length to incorporate different electronic circuitry and/or different internal antenna systems that may vary in size due to number of spatially separated antenna resonators, frequency of operation, radiation pattern, polarization, and characteristic impedance.

In accordance with the present invention, the capsule 131 comprises one non-metallic portion. While one could attempt to break the non-metallic portion into two portions comprising a non-metallic portion for housing the antenna system, whereby allowing radio wave penetration, and another portion of non-metallic or metallic material, whereby attempting to design around or improve the patent, the insubstantial change in dividing the non-metallic portion to multiple portions would in effect be deemed equivalent to the present invention since it would perform substantially the same function, in substantially the same way, to yield substantially the same result.

FIG. 2B is an end view of the wireless communication device 101 of FIG. 1B, looking at the end with potting compound.

FIG. 3B is a cross sectional view of the wireless communication device 101 of FIG. 1B. As illustrated, the communication device 101 includes the capsule 131 and a plurality of internal components. The capsule 131 encases the plurality of internal components, providing covering, and protection. The plurality of internal components, for example, can include an RF transceiver 345, (or alternatively a separate RF transmitter and RF receiver (not shown)), a power supply portion 384, a data converter portion 383, and the like. The transducer 322 may be a temperature transducer, pressure transducer, or the like. A portion of the transducer 322 may extend to the exterior of the capsule for proper operation. The plurality of internal components, in accordance with the present invention, preferably further includes an antenna RF switch 352, an antenna resonator 351, and an antenna grounding structure 353. The plurality of internal components further can comprise, as described previously herein for functionality, of I/O circuit protection, programmable controllers, a frequency synthesizer, a signal processor, serial data UART devices, voltage level conditioner circuits, threshold comparators, A/D converters, D/A converters, driver circuits, linear regulators, storage capacitors, inductors, diodes, switch mode controller integrated circuit, and the like. A printed circuit board 340 provides conducted electrical connection and mechanical structure between the plurality of internal components within the wireless communication device 101 as illustrated.

FIG. 3B further illustrates one embodiment of the wireless modem portion 350 for use within the wireless communication device 101 in accordance with the present invention and the relationship of the various portions of the wireless modem portion 350 with the various portions of the capsule 131. As illustrated, the wireless modem portion 350, in accordance with a preferred embodiment of the present invention, comprises a printed circuit board 340 and associated internal components connected therein preferably housed within non-metallic capsule 131 as previously described herein. The wireless modem 350 further preferably comprises an antenna system contained within the non-metallic capsule 131. It will further be appreciated by those of ordinary skill in the art that the wireless modem 350 can be utilized for all communication protocols such as FHSS (Frequency Hopping Spread Spectrum), DSSS (Direct Sequence Spread Spectrum), DTS (Digital Modulation Spectrum), WLAN (Wireless Local Area Network), TDMA (time division multiple access), CDMA (Code Division Multiple Access), GSM (Global System for Mobile Communication), and the like. It will be further appreciated that the wireless modem 350 can be utilized for data transmit and receive such as operating with GPRS (General Packet Radio Service), EDGE (An edge device is a physical device that can pass packets between a legacy type of network such as an Ethernet network and an ATM network, using Data Link layer and Network layer information), 3G (third-generation wireless) for facilitating the use of wireless data transfer, Internet access, and the like.

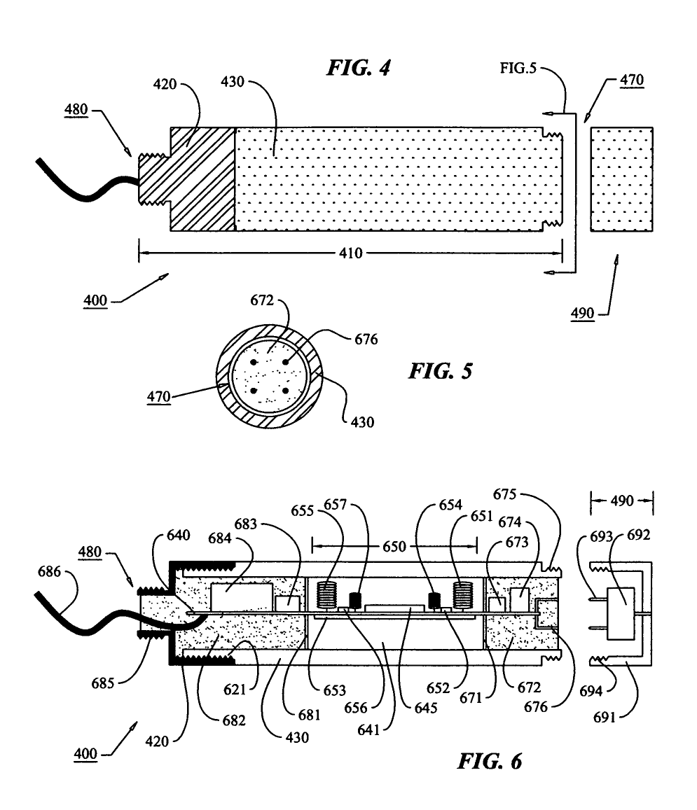

The illustrated wireless communication device 400 in FIG. 4, by way of example only, is another preferred embodiment of a wireless communication device, in accordance with the present invention, having a conventional wireless modem circuitry, data converter circuitry, and power supply circuitry, as is known in the art, and will not be presented here for simplicity. Although the invention is illustrated herein with reference to a wireless communication device for hazardous locations, the invention is alternatively applied to other applications such as, for example, supervisory control and data acquisition of devices in non-hazardous locations like residential, commercial, and industrial security systems with electrochemical sensors, radiated energy sensors, and solenoid actuators.

The wireless communication device 400, as illustrated, includes a capsule 410 for covering, protecting and supporting the internal components encased within, along with providing mechanical structure for interfacing to external devices, transducers, sensors, and the like. By way of example, the preferred embodiment of the present invention is described in relation to a fixed housing such as the capsule 410 of FIG. 4; however, it will be appreciated by one of ordinary skill in the art that the present invention is similarly applicable to a housing of different shape and length to incorporate different electronic circuitry and/or different internal antenna systems that may vary in size due to number of spatially separated antenna resonators, frequency of operation, radiation pattern, polarization, and characteristic impedance.

In accordance with the present invention, the capsule 410 comprises a conduit fitting portion 420 and a non-metallic portion 430. The non-metallic portion 430, for example, can be manufactured by a plastic injection molding technique as is well known in the art. The conduit fitting portion 420 is preferably made of a material to provide the capsule 410 a rigid metal conduit mechanical interface structure with more strength than a housing comprised totally of the non-metallic portion 430 material so that the conduit port 480 will be in accordance with Article 501 in the National Electric Code (“NEC”) ANSI/NFPA 70-2005. The conduit fitting portion 420, for example, can be manufactured using any material which from a mechanical point of view is any physical element showing very high tensile strength. Such materials include iron, aluminum, stainless steel, or a non-metallic material with similar strength to achieve the same result. The conduit fitting portion 420 provides strength and rigidity over a non-metallic material, such as glass reinforced plastic, used for the non-metallic portion 430. While one could attempt to integrate the conduit fitting portion 420 with the non-metallic portion 430 to create an integrated single piece housing and manufacture the integrated housing out of a high-grade non-metallic material in order to design around or improve the patent, the insubstantial change to an integrated single piece housing would in effect be deemed equivalent to the present invention since it would perform substantially the same function, in substantially the same way, to yield substantially the same result.

In accordance with the present invention, the capsule 410 comprises one non-metallic portion 430 and one conduit fitting portion 420. While one could attempt to break the non-metallic portion 430 into two portions comprising a non-metallic portion for housing the antenna system, whereby allowing radio wave penetration, and another portion of non-metallic or metallic material, whereby attempting to design around or improve the patent, the insubstantial change in dividing the non-metallic portion 430 to multiple portions would in effect be deemed equivalent to the present invention since it would perform substantially the same function, in substantially the same way, to yield substantially the same result.

FIG. 5 is an end view of the wireless communication device 400 of FIG. 4, looking at the intrinsically safe circuit interface port 470.

FIG. 6 is a cross sectional view of the wireless communication device 400 of FIG. 4. As illustrated, the communication device 400 includes the capsule 410 and a plurality of internal components. The capsule 410 encases the plurality of internal components, providing covering, protection, and interface port mechanical structural support. The plurality of internal components, for example, can include an RF transceiver 645, (or alternatively a separate RF transmitter and RF receiver (not shown)), interface lead wires serving as a plurality of conduit port electrical conductors 686, a power supply portion 684, a data converter portion 683, a plurality of intrinsically safe interface port electrical conductors 676, an intrinsically safe power supply portion 674, an intrinsically safe data converter portion 673, and the like. The plurality of internal components, in accordance with the present invention, preferably further includes a first antenna RF switch 652, a second antenna RF switch 656, a first antenna resonator 651, a second antenna resonator 654, a third antenna resonator 655, a forth antenna resonator 657, and an antenna grounding structure 653. The plurality of internal components further can comprise, as described previously herein for functionality, of I/O circuit protection, programmable controllers, a frequency synthesizer, a signal processor, serial data UART devices, voltage level conditioner circuits, threshold comparators, A/D converters, D/A converters, driver circuits, linear regulators, storage capacitors, inductors, diodes, switch mode controller integrated circuit, and the like. A printed circuit board 640 provides conducted electrical connection and mechanical structure between the plurality of internal components within the wireless communication device 400 as illustrated.

In accordance with the present invention, the capsule 410 comprises one non-metallic portion 430 and one conduit fitting portion 420 joined together by assembly of two mating threaded sections to make the threaded joint 621. While one could attempt to use a rabbet joint, straight or flat joint, labyrinth joint, or the like instead of the theaded joint 621 as specified in the present embodiment, whereby attempting to design around or improve the patent, the insubstantial change to a different type of mating joint would in effect be deemed equivalent to the present invention since it would perform substantially the same function, in substantially the same way, to yield substantially the same result.

In accordance with the present invention, an antenna system for the wireless communication device 400 using a multiple antenna diversity method, comprises a first antenna resonator 651, a second antenna resonator 654, a third antenna resonator 655, a forth antenna resonator 657, a first antenna RF switch 652, a second antenna RF switch 656, and an antenna grounding structure 653. The antenna resonators and the antenna grounding structure referred herein can be built in different ways and using different technologies as is well known in the art. For example, an antenna resonator can be a helix-whip coupled to quarter-wave image grounding structure, a meandered encapsulated flexible circuit, a meandered none encapsulated flexible circuit, one or more meandered wires, any combination of active and parasitic radiators, and the like. The antenna system functions using the combination of all the mechanical parts that constitute the antenna system and its switches necessary to carry the RF signal from and towards the RF transceiver 645 including for example the first antenna resonator 651, the first antenna RF switch 652, coupled between the first antenna resonator 651 and the RF transceiver 645. The antenna system is for radiating and collecting radio wave energy and is coupled and matched to the RF transceiver 645 with circuitry within the plurality of internal components such as the first antenna RF switch 652 as is known in the art.

As illustrated, the antenna system is located within the non-metallic portion 430 of the capsule 410 in accordance with the present invention. Locating the plurality of antenna resonators, the antenna RF switches, and the antenna grounding structure within the non-metallic portion 430 decreases the probability of the antenna system being shielded or detuned from the impedance of interest, thereby providing consistent overall antenna system performance efficiency. While one could attempt to use a conduit fitting portion 420 made of metal as a portion of the antenna resonators or a portion of the antenna grounding structure instead of locating them entirely in the non-metallic portion as specified in the present invention, whereby attempting to design around or improve the patent, the insubstantial change to the antenna system would in effect be deemed equivalent to the present invention since it would perform substantially the same function, in substantially the same way, to yield substantially the same result.

As illustrated in FIG. 6, the wireless communication device 400 includes a conduit port 480 for electromechanical interfacing to a rigid metal electrical conduit connection system or to an electrical enclosure, junction box, or the like. The conduit fitting portion 480 has within a conduit sealing compound 682 to incorporate a factory-installed conduit seal, as previously defined herein. The factory-installed conduit seal is specified to withstand a minimum 600 PSIG hydrostatic pressure test applied at the conduit port 480, whereby the conduit fitting portion 420, conduit port threaded portion 685, and the conduit sealing compound 682 are designed to withstand the force of an explosion, eliminating the need for a separate conduit seal at the point where the device connects to an electrical conduit, an electrical enclosure, or the like. The interface lead wires protruding out the conduit port 480, and having the conduit sealing compound 682 forming a seal around each electrical conductor, provide conducted electrical coupling to the power supply portion 684 and the data converter portion 683.

In accordance with the present invention, the conduit port 480 has within a conduit sealing compound 682 to incorporate a factory-installed conduit seal, as previously defined herein. While one could attempt to remove the conduit sealing compound 682 in order to design around or improve the patent, the insubstantial change would in effect be deemed equivalent since an external conduit seal must then be installed and the wireless communications device would perform substantially the same function, in substantially the same way, to yield substantially the same result.

As illustrated in FIG. 6, a conduit sealing compound barrier 681 prevents the conduit sealing compound 682 from entering the wireless modem cavity 641. While one could attempt to remove the conduit sealing compound barrier 681 and fill the wireless modem cavity 641 with a sealing compound or potting material in order to design around or improve the patent, the insubstantial change would in effect be deemed equivalent since it would perform substantially the same function, in substantially the same way, to yield substantially the same result.

In accordance with the present invention, the conduit port threaded portion 685 is specified as an external thread on the first end of the conduit fitting portion 420 for interfacing to a rigid metal conduit connection system, or the like. While one could attempt to use an internal thread for the conduit port threaded portion 685 instead of an external thread as specified in the present invention, whereby attempting to design around or improve the patent, the insubstantial change to the different gender thread would in effect be deemed equivalent to the present invention since it would perform substantially the same function, in substantially the same way, to yield substantially the same result.

FIG. 6 further illustrates one embodiment of the wireless modem portion 650 for use within the wireless communication device 400 in accordance with the present invention and the relationship of the various portions of the wireless modem portion 650 with the various portions of the capsule 410. As illustrated, the wireless modem portion 650, in accordance with a preferred embodiment of the present invention, comprises a printed circuit board 640 and associated internal components connected therein preferably housed within the non-metallic portion 430 of the capsule 410 as previously described herein. The wireless modem 650 further preferably comprises an antenna system contained within the non-metallic portion 430 of the capsule 410. The antenna system, for example, can use a multiple antenna diversity method of a plurality of antennas comprising a first antenna resonator 651 designed for horizontal polarization, and/or a second antenna resonator 654 designed for vertical polarization, and/or a third antenna resonator 655 designed for an alternate frequency band, and/or a forth antenna resonator 657 designed for spatial diversity from the first antenna resonator 651. It will be appreciated by those of ordinary skill in the art that the plurality of antennas can include any count of one or more antenna resonators or combination of antenna resonators designed to any combination of polarizations, frequencies, and spatial diversities as desired in accordance with the present invention. The antenna resonators polarization and spatial diversity can include, for example, vertical polarization, horizontal polarization, quarter wavelength spatial diversity of the first horizontal polarized antenna, quarter wavelength spatial diversity of the first vertical polarized antenna, and the like. It will further be appreciated by those of ordinary skill in the art that the wireless modem 650 and its multiple antenna diversity system can be utilized for all communication protocols such as FHSS (Frequency Hopping Spread Spectrum), DSSS (Direct Sequence Spread Spectrum), DTS (Digital Modulation Spectrum), WLAN (Wireless Local Area Network), TDMA (time division multiple access), CDMA (Code Division Multiple Access), GSM (Global System for Mobile Communication), and the like. It will be further appreciated that the wireless modem 650 can be utilized for data transmit and receive such as operating with GPRS (General Packet Radio Service), EDGE (An edge device is a physical device that can pass packets between a legacy type of network such as an Ethernet network and an ATM network, using Data Link layer and Network layer information), 3G (third-generation wireless) for facilitating the use of wireless data transfer, Internet access, and the like.

As illustrated in FIG. 4, the wireless communication device 400 includes an intrinsically safe circuit interface port 470 for electromechanical interfacing to an external device, external transducer module 490, or the like. Such a transducer module 490 may be a camera, microphone, speaker, piezoelectric device, electrochemical sensor, electromechanical transducer, analog output transducer, digital output transducer, or the like, and may sense gas, temperature, pressure, flow rate, vibration, torsion, mechanical stress, liquid level, or other parameters of interest which may be monitored periodically or otherwise on command. The transducer module 490 could comprise of a transducer 692, transducer module housing 691, transducer electrical conductors 693, and transducer mechanical connector 694. The transducer module 490 may electrically connect through a cable conductor to another external device for supervisory control of devices such as control relays, shutoff valves, or the like. The transducer module 490 coupled to the wireless communications device 400 through the intrinsically safe circuit interface port 470 transmits and/or receives analog or digital signal and power through the plurality of intrinsically safe interface port electrical conductors 676.

In accordance with the present invention, the intrinsically safe circuit interface port 470 is intrinsically safe for use in hazardous locations, which is incapable of causing ignition. Thus, the encapsulated enclosure casting compound 672 within the intrinsically safe circuit interface port 470 and encapsulating the plurality of intrinsically safe interface port electrical conductors 676 provides electrical and mechanical isolation between the surrounding explosive atmosphere of the capsule and the ignition sources of the electronic system internal to the capsule. The intrinsically safe circuit interface port mechanical connector 675 provides a mechanical interface for devices such as the transducer module 490. The plurality of intrinsically safe interface port electrical conductors 676 provide electrical connection to the intrinsically safe power supply portion 674 and the intrinsically safe data converter portion 673 for external devices such as the transducer module 490, or the like.

As illustrated in FIG. 6, an encapsulated enclosure casting compound barrier 681 prevents the encapsulated enclosure casting compound 672 from entering the wireless modem cavity 641. While one could attempt to remove the encapsulated enclosure casting compound barrier 681 and fill the wireless modem cavity 641 with a sealing compound or potting material in order to design around or improve the patent, the insubstantial change would in effect be deemed equivalent since it would perform substantially the same function, in substantially the same way, to yield substantially the same result.

In accordance with the present invention, the intrinsically safe circuit interface port 470 comprises an intrinsically safe circuit interface port mechanical connector 675 and a plurality of intrinsically safe interface port electrical conductors 676 for interfacing to external devices such as the transducer module 490, or the like. By way of example, the preferred embodiment of the present invention is described in relation to a threaded portion of the housing as the intrinsically safe circuit interface port mechanical connector 675 and described in relation to a socket connector as the plurality of intrinsically safe interface port electrical conductors 676; however, it will be appreciated by one of ordinary skill in the art that the present invention is similarly applicable to an external device, or transducer module 490, or the like, of different mechanical and electrical interconnections to incorporate different devices or transducer types that may vary in size and function.

In accordance with the present invention, the interface lead wires 686 protruding from the conduit port 480 are coupled to the power supply portion 684, whereby providing a means for the power supply portion 684 to receive electrical power from an external source connected to the conduit port 480. The power supply portion 684 is coupled to the data converter portion 683, the intrinsically safe power supply portion 674, the intrinsically safe data converter portion 673, and the wireless modem portion 650, whereby the power supply portion 684 is capable of providing electrical power to the data converter portion 683, the intrinsically safe power supply portion 674, the intrinsically safe data converter portion 673, and the wireless modem portion 650.

In accordance with the present invention, the interface lead wires 686 protruding from the conduit port 480 are coupled to the data converter portion 683, whereby providing a means for the data converter portion 683 to transfer data with an external electronic device connected to the conduit port 480. The data converter portion 683 is coupled to the wireless modem portion 650, whereby providing wireless data communication ability for an external electronic device connected to the conduit port 480.

In accordance with the present invention, the plurality of intrinsically safe interface port electrical conductors 676 are coupled to the intrinsically safe data converter portion 673, whereby providing a means for the intrinsically safe data converter portion 673 to transfer data with an external electronic device, or transducer module 490, or the like. The intrinsically safe data converter portion 673 is coupled to the wireless modem portion 650, whereby providing wireless data communication ability for an external electronic device, or transducer module 490, or the like, connected to the intrinsically safe circuit interface port 470.

In accordance with the present invention, the intrinsically safe data converter portion 673 further preferably is coupled to the data converter portion 683, whereby providing conducted electrical data communication ability between an external electronic device connected to the intrinsically safe circuit interface port 470 and an external electronic device connected to the conduit port 480.

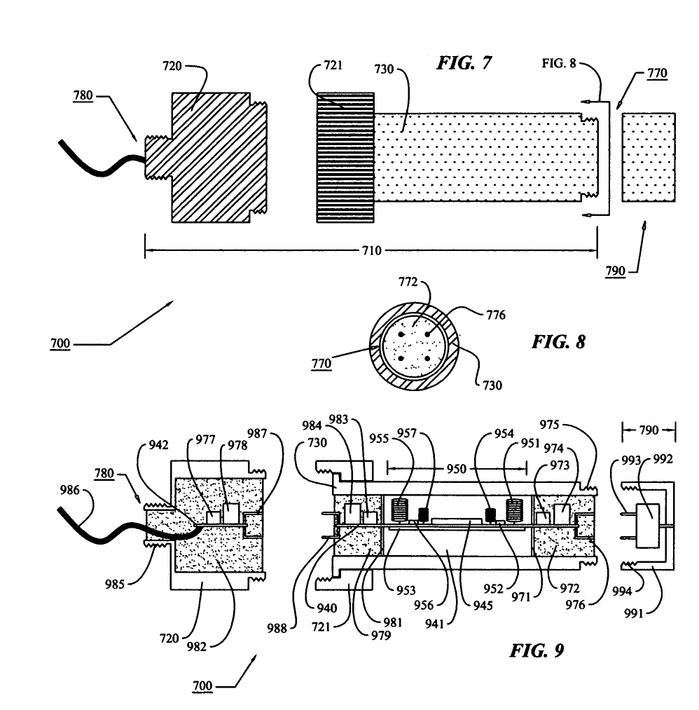

The illustrated wireless communication device 700 in FIG. 7, by way of example only, is another preferred embodiment of a wireless communication device, in accordance with the present invention, having a conventional wireless modem circuitry, data converter circuitry, and power supply circuitry, as is known in the art, and will not be presented here for simplicity. Although the invention is illustrated herein with reference to a wireless communication device for hazardous locations, the invention is alternatively applied to other applications such as, for example, supervisory control and data acquisition of devices in non-hazardous locations like residential, commercial, and industrial security systems with electrochemical sensors, radiated energy sensors, and solenoid actuators.

The wireless communication device 700, as illustrated, includes a capsule 710 for covering, protecting and supporting the internal components encased within, along with providing mechanical structure for interfacing to external devices, transducers, sensors, and the like. By way of example, the preferred embodiment of the present invention is described in relation to a fixed housing such as the capsule 710 of FIG. 7; however, it will be appreciated by one of ordinary skill in the art that the present invention is similarly applicable to a housing of different shape and length to incorporate different electronic circuitry and/or different internal antenna systems that may vary in size due to number of spatially separated antenna resonators, frequency of operation, radiation pattern, polarization, and input impedance.

In accordance with the present invention, the capsule 710 comprises a conduit fitting portion 720 and a non-metallic portion 730. The non-metallic portion 730, for example, can be manufactured by a plastic injection molding technique as is well known in the art. The conduit fitting portion 720 is preferably made of a material to provide the capsule 710 a rigid metal conduit mechanical interface structure with more strength than a housing comprised totally of the non-metallic portion 730 material so that the conduit port 780 will be in accordance with Article 501 in the National Electric Code (“NEC”) ANSI/NFPA 70-2005. The conduit fitting portion 720, for example, can be manufactured using any material which from a mechanical point of view is any physical element showing very high tensile strength. Such materials include iron, aluminum, stainless steel, or a non-metallic material with similar strength to achieve the same result. The conduit fitting portion 720 provides strength and rigidity over a non-metallic material, such as glass reinforced plastic, used for the non-metallic portion 730. While one could attempt to integrate the conduit fitting portion 720 with the non-metallic portion 730 to create an integrated single piece housing and manufacture the integrated housing out of a high-grade non-metallic material in order to design around or improve the patent, the insubstantial change to an integrated single piece housing would in effect be deemed equivalent to the present invention since it would perform substantially the same function, in substantially the same way, to yield substantially the same result.

In accordance with the present invention, the capsule 710 comprises one non-metallic portion 730 and one conduit fitting portion 720. While one could attempt to break the non-metallic portion 730 into two portions comprising a non-metallic portion for housing the antenna system, whereby allowing radio wave penetration, and another portion of non-metallic or metallic material, whereby attempting to design around or improve the patent, the insubstantial change in dividing the non-metallic portion 730 to multiple portions would in effect be deemed equivalent to the present invention since it would perform substantially the same function, in substantially the same way, to yield substantially the same result.

In accordance with the present invention, the capsule 710 comprises one non-metallic portion 730 and one conduit fitting portion 720 joined together by assembly of two mating threaded sections with a mating thread joint collar 721. The mating thread joint collar 721 allows field disassembly and joining of the non-metallic portion 730 and conduit fitting portion 720. While one could attempt to use a rabbet joint, straight or flat joint, labyrinth joint, or the like instead of the mating thread joint collar 721 as specified in the present embodiment, whereby attempting to design around or improve the patent, the insubstantial change to a different type of mating joint would in effect be deemed equivalent to the present invention since it would perform substantially the same function, in substantially the same way, to yield substantially the same result.

FIG. 8 is an end view of the wireless communication device 700 of FIG. 7, looking at the intrinsically safe circuit interface port 770.

FIG. 9 is a cross sectional view of the wireless communication device 700 of FIG. 7. As illustrated, the communication device 700 includes the capsule 710 and a plurality of internal components. The capsule 710 encases the plurality of internal components, providing covering, protection, and interface port mechanical structural support. The plurality of internal components, for example, can include an RF transceiver 945, (or alternatively a separate RF transmitter and RF receiver (not shown)), interface lead wires 986 serving as a plurality of conduit port electrical conductors, first plurality of mating joint electrical conductors 987, second plurality of mating joint electrical conductors 988, plurality of intrinsically safe interface port electrical conductors 976, first intrinsically safe power supply portion 974, first intrinsically data converter portion 973, second intrinsically safe power supply portion 984, second intrinsically data converter portion 983, third intrinsically safe power supply portion 978, third intrinsically data converter portion 977, and the like. The plurality of internal components, in accordance with the present invention, preferably further includes a first antenna RF switch 952, a second antenna RF switch 956, a first antenna resonator 951, a second antenna resonator 954, a third antenna resonator 955, a forth antenna resonator 957, and an antenna grounding structure 953. The plurality of internal components further can comprise, as described previously herein for functionality, of I/O circuit protection, programmable controllers, a frequency synthesizer, a signal processor, serial data UART devices, voltage level conditioner circuits, threshold comparators, A/D converters, D/A converters, driver circuits, linear regulators, storage capacitors, inductors, diodes, switch mode controller integrated circuit, and the like. First printed circuit board 940 and second printed circuit board 942 provide conducted electrical connection and mechanical structure between the pluralities of internal components within the wireless communication device 700 as illustrated.

In accordance with the present invention, an antenna system for the wireless communication device 700 using a multiple antenna diversity method, comprises a first antenna resonator 951, a second antenna resonator 954, a third antenna resonator 955, a forth antenna resonator 957, a first antenna RF switch 952, a second antenna RF switch 956, and an antenna grounding structure 953. The antenna resonators and the antenna grounding structure referred herein can be built in different ways and using different technologies as is well known in the art. For example, an antenna resonator can be a helix-whip coupled to quarter-wave image grounding structure, a meandered encapsulated flexible circuit, a meandered none encapsulated flexible circuit, one or more meandered wires, any combination of active and parasitic radiators, and the like. The antenna system functions using the combination of all the mechanical parts that constitute the antenna system and its switches necessary to carry the RF signal from and towards the RF transceiver 945 including for example the first antenna resonator 951, the first antenna RF switch 952, coupled between the first antenna resonator 951 and the RF transceiver 945. The antenna system is for radiating and collecting radio wave energy and is coupled and matched to the RF transceiver 945 with circuitry within the plurality of internal components such as the first antenna RF switch 952 as is known in the art.

As illustrated, the antenna system is located within the non-metallic portion 730 of the capsule 7 loin accordance with the present invention. Locating the plurality of antenna resonators, the antenna RF switches, and the antenna grounding structure within the non-metallic portion 730 decreases the probability of the antenna system being shielded or detuned from the impedance of interest, thereby providing consistent overall antenna system performance efficiency. While one could attempt to use a conduit portion 720 made of metal as a portion of the antenna resonators or a portion of the antenna grounding structure instead of locating them entirely in the non-metallic portion as specified in the present invention, whereby attempting to design around or improve the patent, the insubstantial change to the antenna system would in effect be deemed equivalent to the present invention since it would perform substantially the same function, in substantially the same way, to yield substantially the same result.

As illustrated in FIG. 9, the wireless communication device 700 includes a conduit port 780 for electromechanical interfacing to a rigid metal electrical conduit connection system or to an electrical enclosure, junction box, or the like. The conduit fitting portion 780 has within a conduit sealing compound 982 to incorporate a factory-installed conduit seal, as previously defined herein. The factory-installed conduit seal is specified to withstand a minimum 600 PSIG hydrostatic pressure test applied at the conduit port 780, whereby the conduit fitting portion 720, conduit port threaded portion 985, and the conduit sealing compound 982 are designed to withstand the force of an explosion, eliminating the need for a separate conduit seal at the point where the device connects to an electrical conduit, an electrical enclosure, or the like. The interface lead wires protruding out the conduit port 780, and having the conduit sealing compound 982 forming a seal around each electrical conductor, provide conducted electrical coupling to the power supply portion 984 and the data converter portion 983.

In accordance with the present invention, the conduit port 780 has within a conduit sealing compound 982 to incorporate a factory-installed conduit seal, as previously defined herein. While one could attempt to remove the conduit sealing compound 982 in order to design around or improve the patent, the insubstantial change would in effect be deemed equivalent since an external conduit seal must then be installed and the wireless communications device would perform substantially the same function, in substantially the same way, to yield substantially the same result.

As illustrated in FIG. 9, a conduit sealing compound barrier 981 prevents the conduit sealing compound 982 from entering the wireless modem cavity 941. While one could attempt to remove the conduit sealing compound barrier 681 and fill the wireless modem cavity 941 with a sealing compound or potting material in order to design around or improve the patent, the insubstantial change would in effect be deemed equivalent since it would perform substantially the same function, in substantially the same way, to yield substantially the same result.

In accordance with the present invention, the conduit port threaded portion 985 is specified as an external thread on the first end of the conduit fitting portion 720 for interfacing to a rigid metal conduit connection system, or the like. While one could attempt to use an internal thread for the conduit port threaded portion 985 instead of an external thread as specified in the present invention, whereby attempting to design around or improve the patent, the insubstantial change to the different gender thread would in effect be deemed equivalent to the present invention since it would perform substantially the same function, in substantially the same way, to yield substantially the same result.

FIG. 9 further illustrates one embodiment of the wireless modem portion 950 for use within the wireless communication device 700 in accordance with the present invention and the relationship of the various portions of the wireless modem portion 950 with the various portions of the capsule 710. As illustrated, the wireless modem portion 950, in accordance with a preferred embodiment of the present invention, comprises a printed circuit board 940 and associated internal components connected therein preferably housed within the non-metallic portion 730 of the capsule 710 as previously described herein. The wireless modem 950 further preferably comprises an antenna system contained within the non-metallic portion 730 of the capsule 710. The antenna system, for example, can use a multiple antenna diversity method of a plurality of antennas comprising a first antenna resonator 951 designed for horizontal polarization, and/or a second antenna resonator 954 designed for vertical polarization, and/or a third antenna resonator 955 designed for an alternate frequency band, and/or a forth antenna resonator 957 designed for spatial diversity from the first antenna resonator 951. It will be appreciated by those of ordinary skill in the art that the plurality of antennas can include any count of one or more antenna resonators or combination of antenna resonators designed to any combination of polarizations, frequencies, and spatial diversities as desired in accordance with the present invention. The antenna resonators polarization and spatial diversity can include, for example, vertical polarization, horizontal polarization, quarter wavelength spatial diversity of the first horizontal polarized antenna, quarter wavelength spatial diversity of the first vertical polarized antenna, and the like. It will further be appreciated by those of ordinary skill in the art that the wireless modem 950 and its multiple antenna diversity system can be utilized for all communication protocols such as FHSS (Frequency Hopping Spread Spectrum), DSSS (Direct Sequence Spread Spectrum), DTS (Digital Modulation Spectrum), WLAN (Wireless Local Area Network), TDMA (time division multiple access), CDMA (Code Division Multiple Access), GSM (Global System for Mobile Communication), and the like. It will be further appreciated that the wireless modem 950 can be utilized for data transmit and receive such as operating with GPRS (General Packet Radio Service), EDGE (An edge device is a physical device that can pass packets between a legacy type of network such as an Ethernet network and an ATM network, using Data Link layer and Network layer information), 3G (third-generation wireless) for facilitating the use of wireless data transfer, Internet access, and the like.

As illustrated in FIG. 7, the wireless communication device 700 includes an intrinsically safe circuit interface port 770 for electromechanical interfacing to an external device, external transducer module 790, or the like. Such a transducer module 790 may be a camera, microphone, speaker, piezoelectric device, electrochemical sensor, electromechanical transducer, analog output transducer, digital output transducer, or the like, and may sense gas, temperature, pressure, flow rate, vibration, torsion, mechanical stress, liquid level, or other parameters of interest which may be monitored periodically or otherwise on command. The transducer module 790 could comprise of a transducer 992, transducer module housing 991, transducer electrical conductors 993, and transducer mechanical connector 994. The transducer module 790 may electrically connect through a cable conductor to another external device for supervisory control of devices such as control relays, shutoff valves, or the like. The transducer module 790 coupled to the wireless communications device 700 through the intrinsically safe circuit interface port 770 transmits and/or receives analog or digital signal and power through the plurality of intrinsically safe interface port electrical conductors 976.

In accordance with the present invention, the intrinsically safe circuit interface port 770 is intrinsically safe for use in hazardous locations, which is incapable of causing ignition. Thus, the encapsulated enclosure casting compound 972 within the intrinsically safe circuit interface port 770 and encapsulating the plurality of intrinsically safe interface port electrical conductors 976 provides electrical and mechanical isolation between the surrounding explosive atmosphere of the capsule and the ignition sources of the electronic system internal to the capsule. The intrinsically safe circuit interface port mechanical connector 975 provides a mechanical interface for devices such as the transducer module 790. The plurality of intrinsically safe interface port electrical conductors 976 provide electrical connection to the intrinsically safe power supply portion 974 and the intrinsically safe data converter portion 973 for external devices such as the transducer module 790, or the like.

As illustrated in FIG. 9, an encapsulated enclosure casting compound barrier 981 prevents the encapsulated enclosure casting compound 972 from entering the wireless modem cavity 941. While one could attempt to remove the encapsulated enclosure casting compound barrier 981 and fill the wireless modem cavity 941 with a sealing compound or potting material in order to design around or improve the patent, the insubstantial change would in effect be deemed equivalent since it would perform substantially the same function, in substantially the same way, to yield substantially the same result.

In accordance with the present invention, the intrinsically safe circuit interface port 770 comprises an intrinsically safe circuit interface port mechanical connector 975 and a plurality of intrinsically safe interface port electrical conductors 976 for interfacing to external devices such as the transducer module 490, or the like. By way of example, the preferred embodiment of the present invention is described in relation to a threaded portion of the housing as the intrinsically safe circuit interface port mechanical connector 975 and described in relation to a socket connector as the plurality of intrinsically safe interface port electrical conductors 676; however, it will be appreciated by one of ordinary skill in the art that the present invention is similarly applicable to an external device, or transducer module 490, or the like, of different mechanical and electrical interconnections to incorporate different devices or transducer types that may vary in size and function.

In accordance with the present invention, the interface lead wires 986 protruding from the conduit port 780 are coupled to the second intrinsically safe power supply portion 984 through path of the third intrinsically safe power supply portion 978, plurality of first mating joint electrical conductors 987, and plurality of second mating joint electrical conductors 988, whereby providing a means for the power supply portion 984 to receive electrical power from an external source connected to the conduit port 780. The power supply portion 984 is coupled to the data converter portion 983, the intrinsically safe power supply portion 974, the intrinsically safe data converter portion 973, and the wireless modem portion 950, whereby the power supply portion 984 is capable of providing electrical power to the data converter portion 983, the intrinsically safe power supply portion 974, the intrinsically safe data converter portion 973, and the wireless modem portion 950.

In accordance with the present invention, the interface lead wires 986 protruding from the conduit port 780 are coupled to the second intrinsically safe data converter portion 983 through path of the third intrinsically safe data converter portion 977, plurality of first mating joint electrical conductors 987, and plurality of second mating joint electrical conductors 988, whereby providing a means for the data converter portion 983 to transfer data with an external electronic device connected to the conduit port 780. The data converter portion 983 is coupled to the wireless modem portion 950, whereby providing wireless data communication ability for an external electronic device connected to the conduit port 780.

In accordance with the present invention, the plurality of intrinsically safe interface port electrical conductors 976 are coupled to the first intrinsically safe data converter portion 973, whereby providing a means for the first intrinsically safe data converter portion 973 to transfer data with an external electronic device, or transducer module 790, or the like. The first intrinsically safe data converter portion 973 is coupled to the wireless modem portion 950, whereby providing wireless data communication ability for an external electronic device, or transducer module 790, or the like, connected to the intrinsically safe circuit interface port 770.

In accordance with the present invention, the first intrinsically safe data converter portion 973 further preferably is coupled to the third data converter portion 977, whereby providing conducted electrical data communication ability between an external electronic device connected to the intrinsically safe circuit interface port 770 and an external electronic device connected to the conduit port 780.

As described, the present invention, including utilizing an antenna system having one or more antenna resonators and accompanying elements located within a non-metallic portion of a communication device housing provides a low Specific Absorption Ratio (SAR) and high efficiency antenna system having a multi-diversity response in frequency, polarization, and spatial diversity that is well suited to serve communication systems such as GPRS and proprietary unlicensed frequency band systems. It further provides an antenna system that also can be use indistinctly for FHSS, DTS, WLAN, GSM, TDMA, AMPS and 3G systems using same or similar form factors. The invention, as described herein, enables an internal antenna compatible with an explosion-proof housing structure thereby providing a hazardous location wireless communications solution for a variety of form factors. Due to its low sensitivity to accessories and features, the present invention is further well suited for implementing intrinsically safe circuits for gas sensors, transducers, video cameras, and other accessories into wireless communication devices for hazardous locations while retaining acceptable radio frequency wireless communications performance. By providing an internal antenna system component, the present invention reduces system installation components count and eliminates conduit connections, thereby reducing the probability of system-level failures caused by lower-level faults of components and conduit connections, resulting in a less expensive and safer electrical equipment installation.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A wireless communication device for transferring radio wave energy to and from a dynamic system, attenuating heat energy intensity produced by said dynamic system, and controlling pressure forces produced by said dynamic system, whereby enabling said dynamic system to communicate with external devices using radio wave communication methods without igniting a surrounding atmosphere of explosive elements concentrations, comprising:
(a) means for capturing said dynamic system in a capsule, whereby containing ignition sources and explosive elements of said dynamic system in the confined capsule interior,
(b) means for propagating said dynamic system generated radio wave energy through said capsule walls, whereby transferring radio wave signals between said dynamic system within capsule interior and external devices beyond capsule walls,
(c) means for absorbing heat energy produced by said dynamic system into said capsule walls, whereby preventing the ignition of explosive elements surrounding said capsule by reducing the temperature of heat energy while traveling a path from the capsule internal region to the capsule external region,
(d) and means for trapping under pressure the hot gases produced by said dynamic system within interior of said capsule, whereby preventing hot gases and flames produced by an explosion within the capsule from escaping capsule walls to the surrounding atmosphere of capsule.

2. A wireless communication device for transferring radio wave energy to and from a dynamic system, attenuating heat energy intensity produced by said dynamic system, and controlling pressure forces produced by said dynamic system, whereby enabling said dynamic system to communicate with external devices using radio wave communication methods without igniting a surrounding atmosphere of explosive elements concentrations, comprising:
(a) means for capturing said dynamic system in a capsule, whereby containing ignition sources and explosive elements of said dynamic system in the confined capsule interior,
(b) means for propagating said dynamic system generated radio wave energy through said capsule walls, whereby transferring radio wave signals between said dynamic system within capsule interior and external devices beyond capsule walls,
(c) means for conducting electrical energy to and from said dynamic system through capsule walls, whereby transferring conducted electrical energy between said dynamic system within capsule interior and external devices beyond capsule walls,
(d) means for absorbing heat energy produced by said dynamic system into said capsule walls, whereby preventing the ignition of explosive elements surrounding said capsule by reducing the temperature of heat energy while traveling a path from the capsule internal region to the capsule external region,
(e) and means for trapping under pressure the hot gases produced by said dynamic system within interior of said capsule, whereby preventing hot gases and flames produced by an explosion within the capsule from escaping capsule walls to the surrounding atmosphere of capsule.

3. A wireless communication device of claim 2, comprising:
(a) a capsule comprising:
i. a conduit fitting portion, wherein the conduit fitting portion comprises:
A. a fitting defining conduit fitting portion first end and conduit fitting portion second end,
B. a hollow cavity between said conduit fitting portion first end and conduit fitting portion second end,
C. a threaded connection at said conduit fitting portion first end,
D. a joint mating section at said conduit fitting portion second end;
ii. a non-metallic portion, wherein the non-metallic portion comprises:
A. a pressure vessel defining non-metallic portion first end and non-metallic portion second end,
B. a hollow cavity between said non-metallic portion first end and non-metallic portion second end,
C. a joint mating section at said non-metallic portion first end,
D. a closed off said non-metallic portion second end, whereby said pressure vessel has only one opening at the said non-metallic portion first end;
iii. means for joining said conduit fitting portion second end to said non-metallic portion first end;
(b) an antenna system, whereby providing the wireless communication device a means to radiate and collect radio wave energy,
i. wherein the antenna system is located within the non-metallic portion of said capsule,
ii. wherein the antenna system comprises one or more antenna resonators;
(c) an electronic system, whereby providing the wireless communication device a means of converting between forms of radio wave signals and conducted electrical signals,
i. wherein the electronic system is located within the capsule,
ii. wherein the electronic system comprises:
A. at least one printed circuit board,
B. at least one power supply portion,
C. at least one data converter portion,
D. a plurality of conduit port electrical conductors,
E. an RF transceiver,
F. and said antenna system;
(d) and a conduit port, whereby providing the wireless communication device an electromechanical interface to external devices,
i. wherein said conduit port is an integral part of the said conduit fitting portion of said capsule,
ii. wherein said conduit port has within said plurality of conduit port electrical conductors,
iii. wherein said conduit port is filled with a conduit sealing compound, whereby creating a factory-installed conduit seal,
iv. wherein said conduit port first end has a threaded section, whereby providing a means for connecting conduit fitting portion first end to an external rigid metal conduit compatible fitting.

4. A wireless communication device for transferring radio wave energy to and from a dynamic system, attenuating heat energy intensity produced by said dynamic system, and controlling pressure forces produced by said dynamic system, whereby enabling said dynamic system to communicate with external devices using radio wave communication methods without igniting a surrounding atmosphere of explosive elements concentrations, comprising:
(a) means for capturing said dynamic system in a capsule, whereby containing ignition sources and explosive elements of said dynamic system in the confined capsule interior,
(b) means for propagating said dynamic system generated radio wave energy through said capsule walls, whereby transferring radio wave signals between said dynamic system within capsule interior and external devices beyond capsule walls,
(c) means for conducting electrical energy to and from said dynamic system through capsule walls, whereby transferring conducted electrical energy between said dynamic system within capsule interior and external devices beyond capsule walls,
(d) means for absorbing heat energy produced by said dynamic system into said capsule walls, whereby preventing the ignition of explosive elements surrounding said capsule by reducing the temperature of heat energy while traveling a path from the capsule internal region to the capsule external region,
(e) and means for trapping under pressure the hot gases produced by said dynamic system within interior of said capsule, whereby preventing hot gases and flames produced by an explosion within the capsule from escaping capsule walls to the surrounding atmosphere of capsule.

5. A wireless communication device of claim 4, comprising:
(a) a capsule comprising:
i. a conduit fitting portion, wherein the conduit fitting portion comprises:
A. a fitting defining conduit fitting portion first end and conduit fitting portion second end,
B. a hollow cavity between said conduit fitting portion first end and conduit fitting portion second end,
C. a threaded connection at said conduit fitting portion first end,
D. a joint mating section at said conduit fitting portion second end;
ii. a non-metallic portion, wherein the non-metallic portion comprises:
A. a pressure vessel defining non-metallic portion first end and non-metallic portion second end,
B. a hollow cavity between said non-metallic portion first end and non-metallic portion second end,
C. a joint mating section at said non-metallic portion first end;
iii. means for joining said conduit fitting portion second end to said non-metallic portion first end;
(b) an antenna system, whereby providing the wireless communication device a means to radiate and collect radio wave energy,
i. wherein the antenna system is located within the non-metallic portion of said capsule,
ii. wherein the antenna system comprises one or more antenna resonators;
(c) an electronic system, whereby providing the wireless communication device a means of converting between forms of radio wave signals and conducted electrical signals,
i. wherein the electronic system is located within the capsule,
ii. wherein the electronic system comprises:
A. one or more printed circuit boards,
B. one or more power supply portions,
C. one or more data converter portions,
D. plurality of conduit port electrical conductors,
E. at least one RF transceiver,
F. said antenna system,
G. and plurality of intrinsically safe interface port electrical conductors;
(d) a conduit port, whereby providing the wireless communication device an electromechanical interface to external devices,
i. wherein said conduit port is an integral part of the said conduit fitting portion of said capsule,
ii. wherein said conduit port has within said plurality of conduit port electrical conductors,
iii. wherein said conduit port is filled with a conduit sealing compound, whereby creating a factory-installed conduit seal,
iv. wherein said conduit port first end has a threaded section, whereby providing a means for connecting conduit fitting portion first end to an external rigid metal conduit compatible fitting;
(e) and one or more intrinsically safe circuit interface ports,
i. wherein at least one intrinsically safe circuit interface port is an integral part of the said non-metallic portion of said capsule,
ii. wherein said one or more intrinsically safe circuit interface ports have said plurality of intrinsically safe circuit interface port electrical conductors,
iii. wherein the one or more intrinsically safe circuit interface ports are filled with an encapsulated enclosure casting compound to create an intrinsically safe electrical barrier between capsule walls and plurality of intrinsically safe circuit interface port electrical conductors.

6. (canceled)

7. (canceled)

8. (canceled)

9. (canceled)

10. (canceled)

11. (canceled)

12. The process of providing a wireless communication device in an explosion-proof housing for use in a hazardous location capable of providing a means for transmitting and receiving conducted electrical energy by one or more electromechanical interface ports comprising at least one conduit port with factory-installed conduit seal and at least one intrinsically safe interface port, whereby allowing external equipment and devices such as transducers, actuators, sensors, and other devices to benefit from data transfer using conducted electrical and wireless communication, by using the wireless communication device of claim 4.

13. (canceled)

14. (canceled)

15. The process of providing a wireless communication device in an explosion-proof housing comprising conduit port with factory-installed conduit seal, an internal antenna system, and one or more intrinsically safe interface ports without the dependence of a separate explosion-proof enclosure, or separate transceiver, or a separate antenna, or separate antenna connector, or separate conduit seals by using the wireless communication device of claim 4.
